(19) United States
(12) Patent Application Publication
(10) Pub. No.: US 2025/0173515 A1
(43) Pub. Date: May 29, 2025

(54) INTELLIGENT DOCUMENT SYSTEM

(71) Applicant: American Express Travel Related Services Company, Inc., New York, NY (US)

(72) Inventor: Andras L. Ferenczi, Scottsdale, AZ (US)

(21) Appl. No.: 18/519,889

(22) Filed: Nov. 27, 2023

(51) Int. Cl. G06F 40/40

(52) U.S. Cl. CPC G06F 40/40

(57) ABSTRACT

Disclosed are various embodiments for an advanced and intelligent document system. A computing device can show a user interface on a display of the computing device, wherein at least a portion of an intelligent dynamic document is presented within the user interface. The computing device can then receive a prompt via the user interface. Subsequently, the computing device can execute a large language model (LLM) to generate a response to the prompt, wherein the LLM is embedded within the intelligent dynamic document and the response is based at least in part on the content of the intelligent dynamic document. Finally, the computing device can present the response within the user interface.

### BACKGROUND

In digital documents, various approaches have been developed for displaying content, such as text and images. A document reader can open certain file extension types (e.g., *.pdf, *.docx, *.txt, etc.) to display the content. Typically, a user is limited to reading, editing the content, and creating minimal annotations, which limits the ability of the user to engage with the document or interact with the document. As a result, a user could have to resort to alternative formats or applications. A static experience could ultimately impact the efficiency of the user and lead to a fragmented reading and learning experience.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIG. 1 is a user interface diagram of an intelligent document system according to various embodiments of the present disclosure.

FIG. 2 is a user interface diagram of an intelligent document system according to various embodiments of the present disclosure.

FIG. 3 is a user interface diagram of an intelligent document system according to various embodiments of the present disclosure.

FIG. 4 is a drawing of a network environment according to various embodiments of the present disclosure.

FIGS. 5A and 5B are a flowchart illustrating one example of functionality implemented as portions of an application executed in a computing environment in the network environment of FIG. 4 according to various embodiments of the present disclosure.

FIG. 6A is a flowchart illustrating one example of functionality implemented as portions of an application executed in a computing environment in the network environment of FIG. 4 according to various embodiments of the present disclosure.

FIG. 6B is a flowchart illustrating one example of functionality implemented as portions of an application executed in a computing environment in the network environment of FIG. 4 according to various embodiments of the present disclosure.

FIG. 7A is a flowchart illustrating one example of functionality implemented as portions of an application executed in a computing environment in the network environment of FIG. 4 according to various embodiments of the present disclosure.

FIG. 7B is a flowchart illustrating one example of functionality implemented as portions of an application executed in a computing environment in the network environment of FIG. 4 according to various embodiments of the present disclosure.

### DETAILED DESCRIPTION

Disclosed are various approaches for an intelligent document system that allows enhanced document interactions and comprehension. Typically, documents are static and do not allow a user to interactions. In some instances, portions of the document could be hard to read or understand, leading users to seek alternative content or tools or other alternative methods, consuming valuable time and resources, lack of efficiency, and a fragmented learning experience.

Previously, a user might have addressed these problems using various approaches. For example, the user could have sought a different document reader with other tools and capabilities. As another example, a user could have used a plurality of applications to achieve a sought after result or experience. Alternatively, a user could have consulted external sources for information regarding the content contained in a document. For example, a user could perform searches using various search engines or call customer service of a financial institution for information about charges on a credit card statement.

In contrast, the approaches herein introduce an intelligent, advanced, and comprehensive document. For example, embodiments of the present disclosure embed a compressed large language model within the document that can be executed to allow a user to actively interact with the intelligent dynamic document. An illustrative and non-limiting example can include a user activating an embedded large language model (“LLM”) and artificial intelligence (“AI”) conversation interface in the intelligent dynamic document to ask questions, seek clarity, or discuss contents of the document. In this illustrative and non-limiting example, a user can input queries in the conversation interface to ask for a summary of the contents of the document. The user could continue to input queries to receive responses from the large language model in the chat interface using previous queries, personalized user data, and other similar data. The user could ask the LLM to annotate parts of the document. Once the user is finished with the conversation, the user can clear the conversation, save the conversation, download the queries and responses, minimize the conversation, or exit the conversation interface.

In some instances, embodiments of the present disclosure can offer suggestions based at least in part on the user input, user preferences, user settings, collaboration settings, and other user information. For example, if a user asks for a summary in the chat interface, the LLM could suggest to highlight the relevant portions of intelligent dynamic document. In some examples, the user could receive a notification with the alternative options.

Techniques described herein of the intelligent document system provide a significant technical improvement by reducing server request frequencies (e.g., continuous search queries from user(s) to understand the contents of the document, etc.), enhancing user interactions (e.g., AI generated annotations, conversation interface, etc.), data retrieval processes (e.g., providing information in the conversation interface, etc.), and/or improved data analysis and reporting (e.g., real-time document analysis by the LLM, analyzing user patterns, etc.). The techniques described herein of the intelligent document system can also provide a significant technical benefit such as refining the user experience (e.g., using a single application, saving time, minimizing external tools, etc.), personalized experiences, and reduced operation costs (e.g., less equipment, fewer personnel, etc.).

In the following discussion, a general description of the system and its components is provided, followed by a discussion of the operation of the same. Although the following discussion provides illustrative examples of the operation of various components of the present disclosure, the use of the following illustrative examples does not exclude other implementations that are consistent with the principals disclosed by the following illustrative examples.

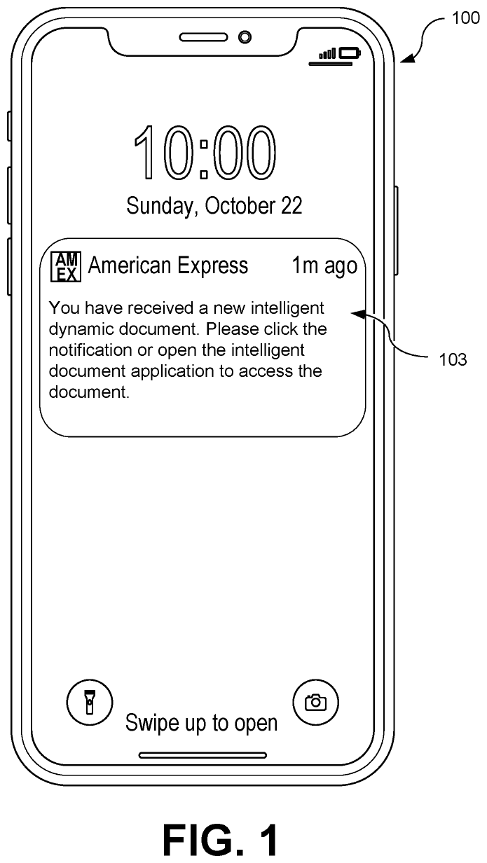

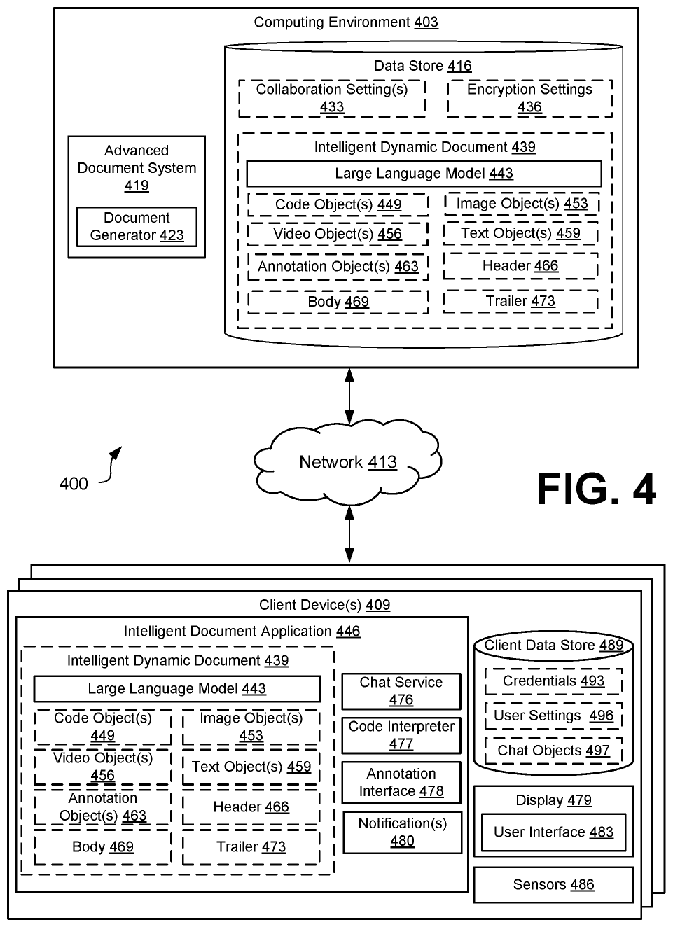

FIG. 1 depicts a client device 100, presenting the user with a notification on the display 479 (FIG. 4) of the client device 100. In some examples, the notification could provide the user with a first notification. In some other examples, the notification could provide the user with a second notification. In some examples, the notification could alert the user that the user has received an intelligent dynamic document 439 (FIG. 4).

In another example, such as the example depicted in FIG. 1, the client device 100 of the user could receive a notification 103 after the intelligent dynamic document 439 (FIG. 4) has been generated, updated, or requires user attention to perform an action (e.g., input credentials, provide encryption/decryption keys, etc.). In some instances when requesting the intelligent dynamic document 439 (FIG. 1), the user can request a downloadable file or link. In such cases, the user could receive a notification 103 on his or her client device 100 informing the user that the user selected mode for the intelligent dynamic document 439 (FIG. 4) is ready/completed.

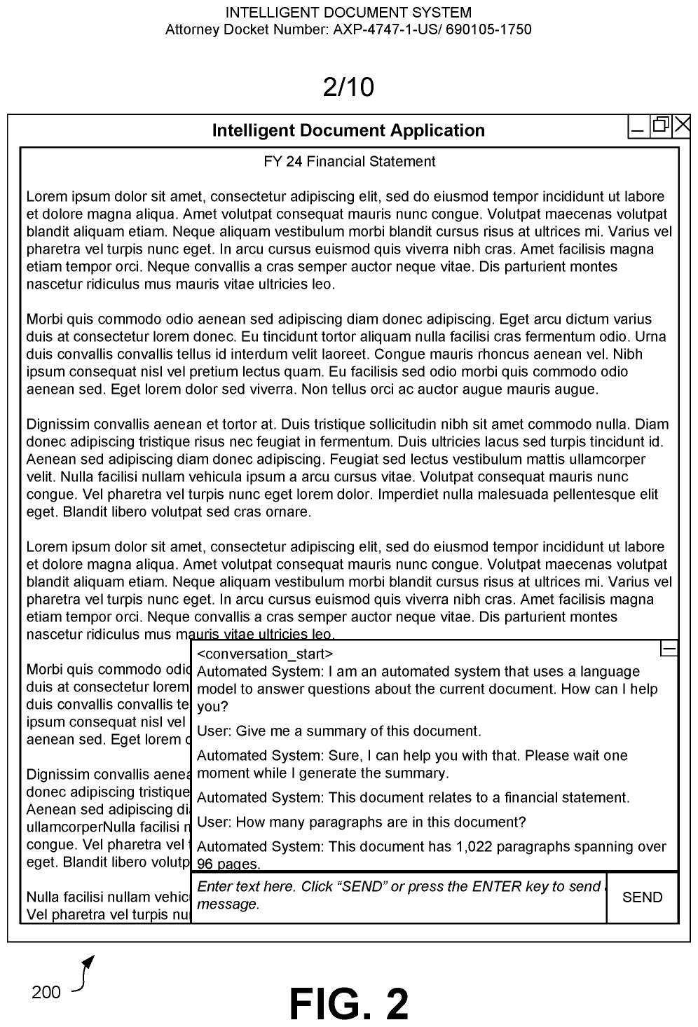

FIG. 2 depicts an example scenario where a user could be viewing an intelligent dynamic document 439 (FIG. 4) using the intelligent document application 446 (FIG. 4) according to various embodiments of the present disclosure. In this example, a user is able to use the intelligent document application 446 (FIG. 4) to converse with a large language model 443 (FIG. 4), annotate the document, or other similar interactions. For example, a user could converse with the large language model 443 (FIG. 4) using a chat interface of the chat service 476 (FIG. 4) to get a summary of the intelligent dynamic document 439 (FIG. 4) without having to spend additional time.

Referring to FIG. 2, shown is a user interface diagram 200 displayed on a display 479 (FIG. 4) of the client device 409 (FIG. 4). In some instances, the user interface 483 (FIG. 4) can be rendered on the display 479 by a web browser. In other instances, the user interface 483 (FIG. 4) can be rendered and displayed on a dedicated application, a mobile application, or other related environments, where the intelligent document application 446 (FIG. 4) can be the application or be an extension of the application advanced document system 419 (FIG. 4). The user interface 483 (FIG. 4) represents an application to interact with a large language model 443 or other users, annotate the intelligent dynamic document 439 (FIG. 4), or intake the contents of the intelligent dynamic document 439 (FIG. 4). The user interface 483 (FIG. 4) can be rendered by the intelligent document application 446 (FIG. 1). In some instances, portions of the user interface 483 (FIG. 4) can be rendered by the chat service 476 (FIG. 4).

With reference to FIG. 2, displayed is the user interface 200 of the intelligent document application 446 (FIG. 1) on the display 479 of the client device 409. The orientation and size of the intelligent dynamic document 439 (FIG. 4) can be adjusted based at least in part on user settings 496 (FIG. 4) or the sensors 486 (FIG. 4) of the client device 409 (FIG. 4). The user can be presented with the intelligent dynamic document 439 (FIG. 4) with various background services running in the background. The user interface 200 can display the chat interface of the chat service 476 (FIG. 4). The user can converse with the large language model 443 (FIG. 4). In some instances, the large language model 443 (FIG. 4) can provide suggestions for annotations. In other examples, the large language model 443 (FIG. 4) can offer content for the intelligent dynamic document 439 (FIG. 4). In other examples, the large language model 443 (FIG. 4) can provide responses to user queries received in the chat interface of the chat service 476. In some instances, the user can clear the conversation, save the conversation, download the queries and responses, minimize the conversation, or exit the conversation interface.

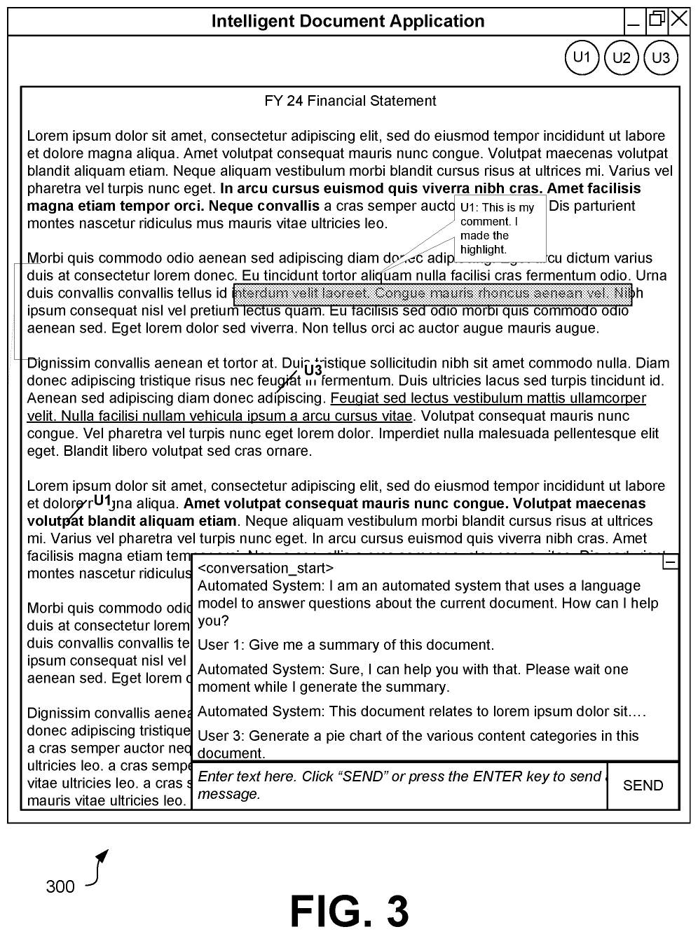

Referring to FIG. 3, shown is a user interface diagram 300 displayed on a display 479 (FIG. 4) of the client device 409 (FIG. 4). In some instances, the user interface 483 (FIG. 4) can be rendered on the display 479 (FIG. 4) by a web browser. In other instances, the user interface 483 (FIG. 4) can be rendered and displayed on a dedicated application, a mobile application, or other related environments, where the intelligent document application 446 (FIG. 4) can be the application. The user interface 483 (FIG. 4) represents an application to converse with a large language model 443 (FIG. 4) or other users, annotate the intelligent dynamic document 439 (FIG. 4), intake the contents of the intelligent dynamic document 439 (FIG. 4), or collaborate on the intelligent dynamic document 439 with one or more users. The user interface 483 (FIG. 4) can be rendered by the intelligent document application 446 (FIG. 4). In some instances, portions of the user interface 483 (FIG. 4) can be rendered by the intelligent document application 446 (FIG. 4) or the chat service 476 (FIG. 4).

With reference to FIG. 3, displayed is the user interface 300 of the intelligent document application 446 (FIG. 4) on the display 479 (FIG. 4) of the client device 409 (FIG. 4). The orientation and size of the intelligent dynamic document 439 (FIG. 4) can be adjusted based at least in part on user settings 496 (FIG. 4) or the sensors 486 (FIG. 4) of the client device 409 (FIG. 4). The user can be presented with the intelligent dynamic document 439 (FIG. 4) with various background services running in the background. The user interface 300 can display the chat interface of the chat service 476 (FIG. 4). The user can converse with the large language model 443 (FIG. 4). In some instances, the large language model 443 (FIG. 4) can provide suggestions for annotations. In other examples, the large language model 443 (FIG. 4) can offer content for the intelligent dynamic document 439 (FIG. 4). In other examples, the large language model 443 (FIG. 4) can provide responses to the user queries received in the chat interface of the chat service 476 (FIG. 4). In some examples, a plurality of users can collaborate on the intelligent dynamic document 439 (FIG. 4). The user interface 300 depicts three users (U1, U2, and U3) that have reviewed or collaborated on the intelligent dynamic document 439 (FIG. 4). The intelligent dynamic document 439 (FIG. 4) contains a plurality of annotations such as formatted text, highlighted text, comments, notes, underlining, and paragraph selections. In some instances, the annotations can be marked with a user identification to denote the user that created the annotation. In other examples, the chat interface of the chat service 476 (FIG. 4) in the user interface 300 can depict a conversation between a user and the large language model 443 (FIG. 4). In some instances, the user can clear the conversation, save the conversation, download the queries and responses, minimize the conversation, or exit the conversation interface. In some instances, the user can command the large language model 443 (FIG. 4) to generate a graphical representation of the data or the content of the intelligent dynamic document 439 (FIG. 4).

As illustrated in FIG. 4, shown is a network environment 400 according to various embodiments. The network environment 400 can include a computing environment 403 and a client device 409, which can be in data communication with each other via a network 413.

The network 413 can include wide area networks (WANs), local area networks (LANs), personal area networks (PANs), or a combination thereof. These networks can include wired or wireless components or a combination thereof. Wired networks can include Ethernet networks, cable networks, fiber optic networks, and telephone networks such as dial-up, digital subscriber line (DSL), and integrated services digital network (ISDN) networks. Wireless networks can include cellular networks, satellite networks, Institute of Electrical and Electronic Engineers (IEEE) 802.11 wireless networks (i.e., WI-FI®), BLUETOOTH® networks, microwave transmission networks, as well as other networks relying on radio broadcasts. The network 413 can also include a combination of two or more networks 413. Examples of networks 413 can include the Internet, intranets, extranets, virtual private networks (VPNs), and similar networks.

The computing environment 403 can include one or more computing devices that include a processor, a memory, and/or a network interface. For example, the computing devices can be configured to perform computations on behalf of other computing devices or applications. As another example, such computing devices can host and/or provide content to other computing devices in response to requests for content.

Moreover, the computing environment 403 can employ a plurality of computing devices that can be arranged in one or more server banks or computer banks or other arrangements. Such computing devices can be located in a single installation or can be distributed among many different geographical locations. For example, the computing environment 403 can include a plurality of computing devices that together can include a hosted computing resource, a grid computing resource, or any other distributed computing arrangement. In some cases, the computing environment 403 can correspond to an elastic computing resource where the allotted capacity of processing, network, storage, or other computing-related resources can vary over time.

Various applications or other functionality can be executed in the computing environment 403. The components executed on the computing environment 403 include an advanced document system 419, and other applications, services, processes, systems, engines, or functionality not discussed in detail herein. Moreover, the advanced document system 419 can contain component applications such as a document generator 423 which can be executed by the computing environment 403.

Also, various data is stored in a data store 416 that is accessible to the computing environment 403. The data store 416 can be representative of a plurality of data stores 416, which can include relational databases or non-relational databases such as object-oriented databases, hierarchical databases, hash tables or similar key-value data stores, as well as other data storage applications or data structures. Moreover, combinations of these databases, data storage applications, and/or data structures may be used together to provide a single, logical, data store. The data stored in the data store 416 is associated with the operation of the various applications or functional entities described below. This data can include collaboration settings 433, encryption settings 436, intelligent dynamic document 439, large language model 443, and potentially other data.

Collaboration settings 433 can represent parameters for guiding a collaborative experience between a plurality of users. The collaboration settings 433 can set user roles, document viewing settings, editing and interaction permissions, and sharing settings. The collaboration settings 433 can contain attributes such as a setting identification, user role identification, edit rights, and view-only modes.

Encryption settings 436 can represent security configurations for protecting the content of the intelligent dynamic document 439. The encryption settings 436 can use a plurality of encryption methods and encoding techniques to ensure data security. In some instances, encryption settings 436 can set user roles, user permissions, data sensitivity levels, system objectives, and other similar settings. The encryption settings 436 can require multifactor authentication, or other end-to-end encryption methods.

The Intelligent dynamic document 439 can represent an advanced document model with a modular framework. The intelligent dynamic document 439 can be structured in many ways. For example, the intelligent dynamic document 439 could contain a header, body, a cross-reference table, and/or a trailer. The header can contain a version number of the intelligent dynamic document 439. The body can contain the one or more data objects. The cross-reference table can allow for random access of the data objects within the intelligent dynamic document 439. The trailer can contain a pointer to the cross-reference table and an end-of-file marker for the intelligent dynamic document 439.

In some instances, the intelligent dynamic document 439 can be accessed through the intelligent document application 446. In some examples, the intelligent dynamic document 439 can be generated by the document generator 423 of the advanced document system 419. In other examples, the intelligent dynamic document 439 can be modified based at least in part on one or more user inputs. In some instances, the intelligent dynamic document 439 can have a plurality of data objects. In some examples, the intelligent dynamic document 439 can be embedded with a large language model 443. The intelligent dynamic document 439 can be updated in real-time based on inputs from a user. The intelligent dynamic document 439 can be accessed by the intelligent document application 446 as a cloud document or be downloaded to be accessed offline.

The large language model 443 can use advanced artificial intelligence capabilities for natural language processing and response generation. The large language model 443 can be trained on the contents of the intelligent dynamic document 439. In some instances, the large language model 443 can be serialized and optimized for the intelligent dynamic document 439. In some instances, the language model 443 contains the neural network weights and configuration parameters. In some instances, the large language model 443 can be compressed. In some instances, the large language model 443 can be executed to analyze, generate, or modify natural language content in the intelligent dynamic document 439. The large language model 443 can rely on sophisticated algorithms and databases to interpret user actions, speech, and other user inputs. In some instances, the large language model 443 can provide suggestions for annotations. In other examples, the large language model 443 can offer content for the intelligent dynamic document 439. In other examples, the large language model 443 can provide responses to user queries. The large language model 443 can be used by the chat service 476 to provide responses and converse with the user. The large language model 443 can interact with the user and analyze the behavior of a user within the intelligent dynamic document 439. In some instances, the large language model 443 can provide feedback and context based on the analyzed user behavior. For example, if a user has selected a portion of the text, the large language model 443 could offer to highlight the text for the user. The large language model 443 can generate data objects and document edits, such as completing sentences, grammar corrections, and other similar intelligent dynamic document 439 modifications. In some instances, the large language model 443 can be an extension or additional feature of the intelligent document application 446. The large language model 443 can contain attributes such as model identification, training data source, version, and performance metrics.

The advanced document system 419 can be executed to generate intelligent dynamic documents 439 with a large language model 443 embedded within the intelligent dynamic document 439. The advanced document system 419 can contain at least a document generator 423. The document generator 423 of the advanced document system 419 can be executed to generate various documents. In some instances, the document generator 423 can be executed to generate an intelligent dynamic document 439. The document generator 423 can use various templates or formatting to generate the intelligent dynamic document 439. In some instances, the document generator 423 can use a plurality of data objects to generate or create the intelligent dynamic document 439. The document generator can encrypt the document using the encryption settings 162.

The client device 409 is representative of a plurality of client devices that can be coupled to the network 413. The client device 409 can include a processor-based system such as a computer system. Such a computer system can be embodied in the form of a personal computer (e.g., a desktop computer, a laptop computer, or similar device), a mobile computing device (e.g., personal digital assistants, cellular telephones, smartphones, web pads, tablet computer systems, music players, portable game consoles, electronic book readers, and similar devices), media playback devices (e.g., media streaming devices, BluRay® players, digital video disc (DVD) players, set-top boxes, and similar devices), a videogame console, or other devices with like capability. The client device 409 can include one or more displays 479, such as liquid crystal displays (LCDs), gas plasma-based flat panel displays, organic light emitting diode (OLED) displays, electrophoretic ink (“E-ink”) displays, projectors, or other types of display devices. In some instances, the display 479 can be a component of the client device 409 or can be connected to the client device 409 through a wired or wireless connection. In some instances, the client device 409 can include one or more sensors 486, such as a location detection unit, an accelerometer, a gyroscope, a camera, fingerprint sensor, iris sensor, and other suitable sensors.

The sensor 486 can be used for dynamically determining the layout of the user interfaces rendered on the display 181b. For instances, text and/or graphics can be relocated based at least in part on a detected orientation (e.g., portrait or landscape) of the display 479 on the client device 409. The text and graphics can be dynamically relocated based on detected gestures (via a touchscreen display) on the display 479. The text and graphics can be dynamically relocated in order to create viewable area in the display 479 for other related text and/or graphics. In some examples, the sensors 486 could be used to capture a biometric marker of the user.

Various data is stored in a client data store 489 that is accessible to the client device 409. The data stored in the client data store 489 is associated with the operation of the various applications or functional entities described below. This data can include credentials 493, the user settings 496, chat objects 497, notification 480, and potentially other data.

The credentials 493 can include data for authenticating the client device 409 with the computing environment 403. Some examples of credentials 493 can include passwords, tokens, biometric keys, session key, and other suitable credential data. In some instances, the credentials 493 can be used to authenticate users into the advanced document system 419 or the intelligent document application 446. The credentials 493 can be securely stored and encrypted to avoid misuse.

The user settings 496 can be personalization and optimizations selected or chosen by the user of the intelligent document application 446. The user settings 496 can be the display settings, notification settings, interaction modes, collaboration modes, data sharing permissions, login settings, and other similar application personalization settings selected by the user. In some instances, the user settings 496 can automatically adapt or change based at least in part on the user behavior.

The chat objects 497 can represent digital records associated with the communication functionalities of the chat service 476. In some examples, the chat objects 497 can capture individual chat sessions between users and the large language model 443. In some examples, the chat objects 497 can include attributes such as a session identifier, user identifier, chat transcripts, and timestamps. The chat objects 497 can also contain user satisfaction scores, user feedback, categorization tags, and other related metadata.

The client device 409 can be configured to execute various applications such as an intelligent document application 446 or other applications. The intelligent document application 446 can be executed in a client device 409 to access network content served up by the computing environment 403 or other servers, thereby rendering a user interface 483 on the display 479. To this end, the intelligent document application 446 can include a browser, a dedicated application, or other executable, and the user interface 483 can include a network page, an application screen, or other user mechanism for obtaining user input. The client device 409 can be configured to execute applications beyond the intelligent document application 446 such as email applications, social networking applications, word processors, spreadsheets, or other applications. The client device 409 can be configured to execute other applications, services, processes, systems, engines, or functionality not discussed in detail herein. Moreover, the intelligent document application 446 can contain component applications such as a chat service 476, code interpreter 477, and annotation interface 478, which can be executed by the client device 409.

Additionally, the client device 409 can be configured to execute various applications such as an intelligent document application 446, chat service 476, code interpreter 477, annotation interface 478, or other applications. The intelligent document application 446 can be executed to interface with the advanced document system 419 and document generator 423. The intelligent document application 446 can be used to display user interfaces for the intelligent dynamic document, chat service 476, code interpreter 477, and annotation interface 478. The intelligent document application 446 can provide data to the chat service 476 and/or the code interpreter 477.

The intelligent document application 446 can be executed to facilitate the operation and/or management of the intelligent dynamic documents 439. In some instances, the intelligent document application 446 can contain additional tools to provide a user with an enhanced and advanced document application. In some instances, the intelligent document application 446 can provide affordances for an interactive and collaborative experience for a plurality of users. The intelligent document application 446 can be a browser plug-in, software application, mobile application, web application, or other similar application. In some instances, the intelligent document application 446 serves as the execution environment for parsing data objects, instantiating code objects 449, and receiving user inputs. In some instances, the intelligent document application 446 can function offline to allow a user to interact with the intelligent dynamic document 439 without a network connection.

The chat service 476 can be executed to facilitate communication between a user and the large language model 443 embedded in the intelligent dynamic document 439. The chat service 476 can link messages to portions of the intelligent dynamic document 439. The chat service can alert a user upon activity in the chat box or the conversation. In some instances, the chat service 476 can parse the user input to determine the intent of the user as related to the intelligent dynamic document 439. The chat service 476 can utilize the large language model 443 to respond to the user query.

The code interpreter 477 can be executed to analyze, process, and execute code strings, scripts, or other coding inputs embedded in the intelligent dynamic document 439. In some examples, the code interpreter 477 can be executed to analyze, process, and execute strings, scripts, and other coding inputs provided by the user. In other instances, the code interpreter 477 can be used to execute the code objects 449 in the intelligent dynamic document 439. The code objects 449 or the user provided inputs can be executed to perform calculations, create annotations, generate simulations, and other similar interactive functions. In some instances, the code interpreter 477 can validate the code for errors, provide feedback, or optimize the code using the large language model 443. In some instances, the code interpreter 477 can be an extension or additional feature of the intelligent document application 446.

Notification 480 can represent information sent to a system or a user about any event, updates, or information that requires attention. The notification 480 can be sent as system alerts, messages, emails, push notifications, or other similar notification styles. The information in the notification 480 can vary based at least in part on the activity causing the notification 480. For example, a user can receive a notification 480 when a user requests to collaborate on an intelligent dynamic document 439. The notification 480 could have attributes such as a notification identifier, user identifier, event identifier, and content.

The annotation interface 478 can be executed to facilitate user interactions with the documents. In some instances, the annotation interface 478 can be used to make annotations in the intelligent dynamic document 439. In some examples, the annotation interface 478 can be used to highlight content of the intelligent dynamic document 439. In some other examples, the annotation interface 478 can be used by the user to make suggestions, comments, or notes in the intelligent dynamic document 439. In some examples, the annotation interface 478 can color code annotations made by a user. In some instances, the annotation interface 478 can categorize annotations, track changes, and create a list of annotations made by the one or more users. In some instances, the annotation interface 478 can be an extension or additional feature of the intelligent document application 446.

The intelligent dynamic document 439 can contain a plurality of data objects. The data object(s) can represent sets of digital information that store the content of the intelligent dynamic document 439. In some instances, the data objects can be a structed set of digital information. In other instances, the data objects can be an unstructured set of digital information. In some instances, the data objects can be code objects 449, image objects 453, video objects 456, text objects 459, annotation objects 463, or other similar data objects.

Code objects 449 can represent strings of programmatic logic or instructions. In some examples, the code objects 449 can represent modular components inserted into the intelligent dynamic document 439. In some examples, the code objects 449 can be executed by the code interpreter 477. In some instances, the code objects 449 can allow the large language model 443 to perform analytical functions and generate responses to the one or more user queries or inputs. In other examples, the code objects 449 can interact with the large language model 443 to process natural language queries and/or trigger data visualization. In some instances, the code objects 449 can be temporary or valid for a provided number of sessions or documents. In some instances, the code objects 449 can be responsible for the user interface behaviors, data processing, version number, or providing other instructions. The code objects 449 can be tested/validated by a code interpreter 477. In some examples, the code objects 449 can contain attributes such as a function name, version number, and other similar metadata.

Image objects 453 can represent various digital photos, images, vector graphics, and other similar digital representations. In some instances, the image objects 453 can be representative of a user profile picture, product images, user avatars, banners, and other similar representations. An image object 453 can have attributes such as image identification, resolution, format, upload timestamp, source, user notes, and related metadata. In some instances, the image objects 453 can be annotated using the annotation interface 478. In other examples, the image objects 453 can be generated based at least in part on the user input in the chat service 476 using the large language model 443.

Video objects 456 can represent multimedia content, animations, digital creations, and other similar content capturing both audio and visual elements. In some examples, the video objects 456 can be embedded into the intelligent dynamic document 439. In other examples, the video objects can be tutorials, informative videos, advertisements, or user-generated content. In some instances, the video objects 456 can be annotated using the annotation objects 463 on the annotation interface 478. The video objects 456 can have attributes such as video identification, duration, resolution, source link, user comments, view counts, and other relevant metadata.

Text objects 459 can represent written content or sequences of written content in the intelligent dynamic document 439. In some instances, the text objects 459 can be instructions, reports, manuals, digital books, or any other text. In some instances, the text objects 459 can be updated in real-time. The text objects 459 can contain attributes such as text identification, character count, author identification, publication timestamp, or other relevant metadata.

Annotation objects 463 can represent highlights, comments, editing tools, bookmarks, tables, and other similar annotations. Additionally, the annotation objects 463 can represent notes or marks added to the content of the intelligent dynamic document 439 for clarity or emphasis. In some instances, the annotations can be used by the user to mark text objects 459, image objects 453, or video objects 456. In other instances, the annotations objects 463 can be used by the user to bookmark sections of the intelligent dynamic document 439. The annotation objects 463 can contain annotations such as annotation identification, associated content identification, creator identification, creation timestamp, annotation type and other metadata.

Next, a general description of the operation of the various components of the network environment 400 is provided. Although the following description provides a general description of the interactions between the various components of the network environment 400, other interactions are also encompassed by the various embodiments of the present disclosure.

To begin, an intelligent dynamic document 439 encompasses an advanced document type that includes at least a plurality of data objects, a large language model 443, header 466, body 469, and a trailer 473. The intelligent dynamic document 439 can be embedded with code, content, and a fine-tuned compressed language model in a secure and accessible file. The intelligent document application 446 provides an advanced user interface with a plurality of user interactions tools to allow a user to interact with the intelligent dynamic document 439. For example, the code interpreter 477 can execute the large language model 443 embedded in the intelligent dynamic document 439. The advanced document system 419 comprises a document generator 423. The document generator 423 can be executed to at least generate an intelligent dynamic document 439. After the document is generated, the advanced document system 419 can provide the user with a downloadable file or generate a link to the intelligent dynamic document 439 to be accessed by the user via the intelligent document application 446.

Next, after the intelligent dynamic document 439 is generated, the user can access the intelligent dynamic document 439 via the intelligent document application 446. The intelligent document application 446 can be a cloud-based web application, a mobile application, or a computer software application. In some instances, the user can open the downloaded file to open the intelligent dynamic document 439 or navigate to the link provided by the advanced document system 419. Once the intelligent dynamic document 439 is opened, the intelligent document application 446 can render the contents and display the intelligent dynamic document.

After accessing the intelligent dynamic document 439 via the intelligent document application 446, the user can interact with the intelligent dynamic document 439. In some instances, the user can annotate the intelligent dynamic document 439 using the annotation interface 478. The user can input queries into a chat interface provided by the chat service 476. The chat service 476 can be used to interact with the large language model 443. The large language model 443 can provide users with annotations, assistance with the content of the document, generating visual representations, or other general queries.

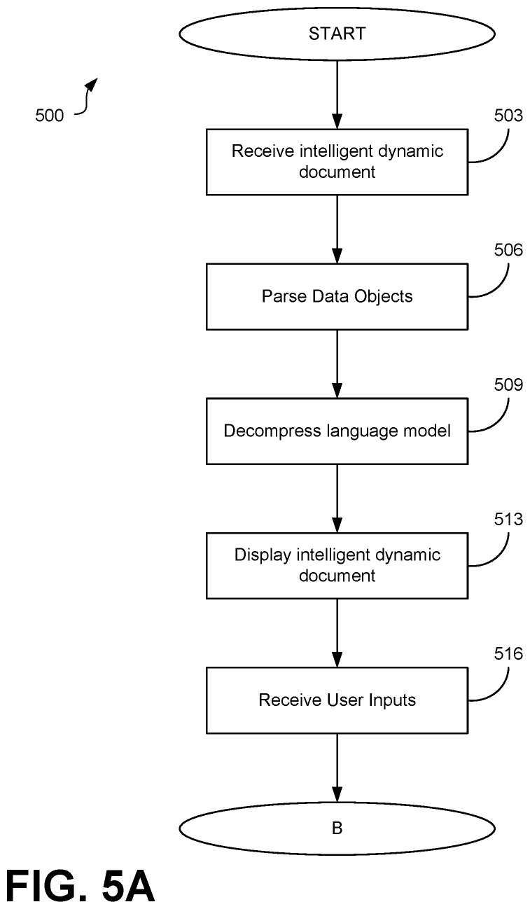

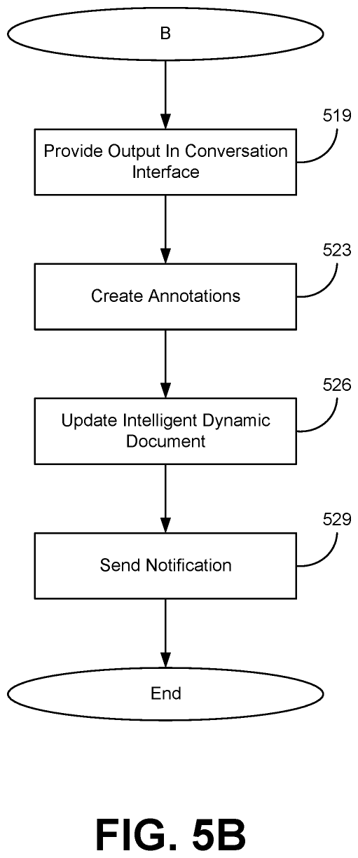

Referring next to FIGS. 5A and 5B, shown is a flowchart that provides one example of the operation of a portion of the intelligent document application 446. The flowchart of FIGS. 5A and 5B provides merely an example of the many different types of functional arrangements that can be employed to implement the operation of the depicted portion of the intelligent document application 446. As an alternative, the flowchart of FIGS. 5A and 5B can be viewed as depicting an example of elements of a method implemented within the network environment 400.

Beginning with block 503, the intelligent document application 446 of the client device 409 can receive an intelligent dynamic document 439. In some instances, the intelligent dynamic document 439 can be received through the network 413. In other instances, the intelligent document application 446 can receive a link (e.g., a web address, etc.) to the intelligent dynamic document 439. In other instances, the intelligent document application 446 can receive the intelligent dynamic document 439 through other various secure digital interfaces.

At block 506, the intelligent document application 446 of the client device 409 can parse the data objects in the intelligent dynamic document 439 that was received. The data objects can represent sets of digital information contained in the intelligent dynamic document 439. In some instances, the data objects can be one or more of code objects 449, image objects 453, video objects 456, text objects 459, annotation objects, or other embedded data. In some instances, the code interpreter 477 can be used to parse the data objects in the intelligent dynamic document 439.

At block 509, the intelligent document application 446 of the client device 409 can decompress the compressed large language model 443 embedded in the intelligent dynamic document 439. The large language model 443 can be used by the chat service to provide information and converse with the user. The large language model 443 can be decompressed using the code interpreter 477 of the intelligent document application 446.

At block 513, the intelligent document application 446 of the client device 409 can display the intelligent dynamic document 439 on the display 479 of the client device 409. The intelligent dynamic document 439 can represent an advanced document model with enhanced user interactions and a modular framework. The intelligent dynamic document 439 can comprise at least a header, body, and a trailer. In some instances, the intelligent dynamic document 439 can have a plurality of data objects.

At block 516, the intelligent document application 446 of the client device 409 can receive one or more user inputs via the user interface 483. In some instances, the intelligent document application 446 can receive one or more user inputs in the chat interface provided by the chat service 476. The one or more inputs can be commands, queries, annotations, or other similar requests. In some instances, the one or more inputs can be based at least in part on the content of the intelligent dynamic document 439.

At block 519, the intelligent document application 446 of the client device 409 can provide one or more outputs based at least in part on the one or more user inputs. In some examples, the outputs can be based at least in part on the parsed content of the intelligent dynamic document 439. In some instances, the outputs can be provided by the large language model 443. In some instances, the outputs can be provided on the chat interface of the chat service 476. In other instances, the output can be the performance of a command, query, annotation, or other similar requests made by the user. In some instances, the response could ask the user for additional information or clarification.

At block 523, the annotation interface 478 of the intelligent document application 446 of the client device 409 can create annotations. In some instances, the annotations can be generated based at least in part on the one or more user inputs. In other examples, the annotations can be created by the user via the annotation interface 478. In some examples, the annotation interface 478 can color code annotations made by a user. In some instances, the annotation interface 478 can categorize annotations, track changes, and create a list of annotations made by the one or more users. In some examples, the annotation interface 478 can be used to highlight content of the intelligent dynamic document 439. In some other examples, the annotation interface 478 can be used by the user to make suggestions, comments, or notes in the intelligent dynamic document 439.

At block 526, the intelligent document application 446 can update the intelligent dynamic document 439 based at least in part on the one or more user inputs. In some instances, the intelligent dynamic document 439 can be updated based at least in part on the output generated by the large language model 443.

At block 529, the intelligent document application 446 can send one or more notification 480 based at least in part on an update in the chat service 476. In some instances, the large language model 443 could generate an output or response after a user has minimized the chat interface of the chat service 476. The intelligent document application 446 can notify a user by system alerts, sound alert, pop-up notification, messages, emails, push notifications, or other similar notification styles. The information in the notification 480 can vary based at least in part on the activity causing the notification 480.

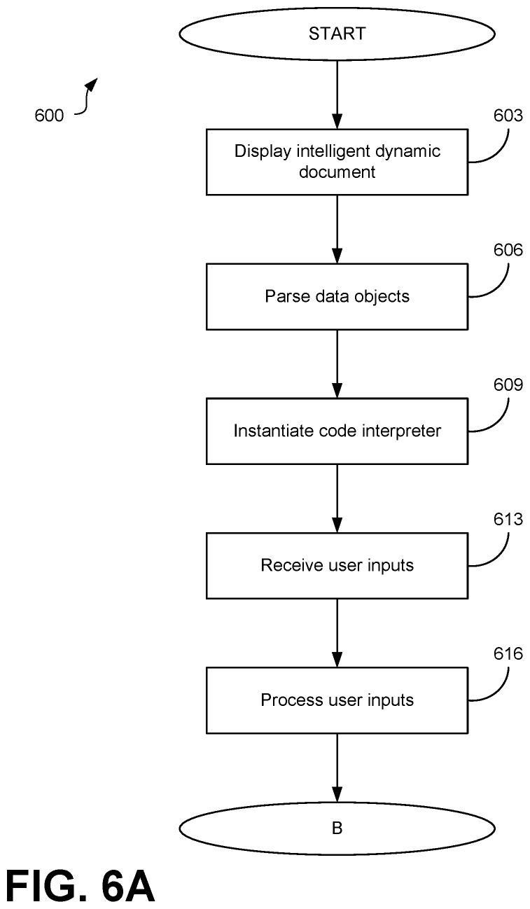

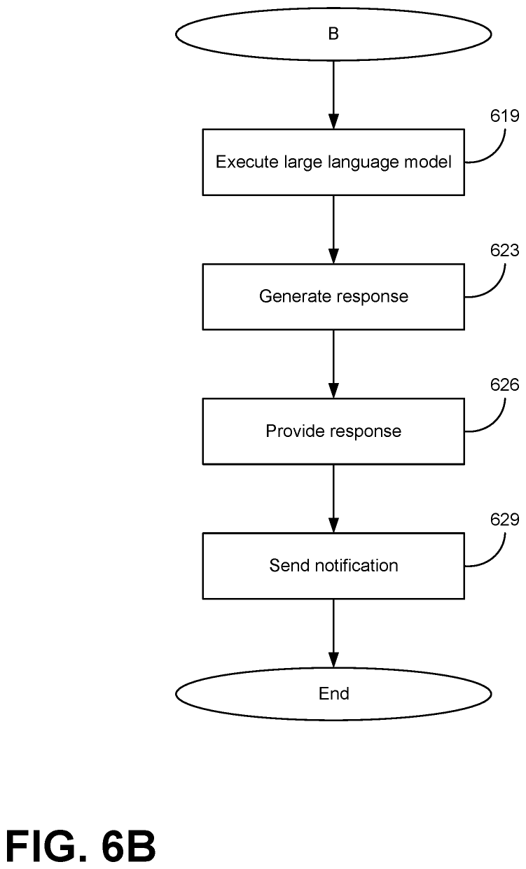

Referring next to FIGS. 6A and 6B, shown is a flowchart that provides one example of the operation of a portion of the intelligent document application 446. The flowchart of FIGS. 6A and 6B provides merely an example of the many different types of functional arrangements that can be employed to implement the operation of the depicted portion of the intelligent document application 446. As an alternative, the flowchart of FIGS. 6A and 6B can be viewed as depicting an example of elements of a method implemented within the network environment 400.

Beginning with block 603, the intelligent document application 446 of the client device 409 can display the intelligent dynamic document 439 on the display 479 of the client device 409. The intelligent dynamic document 439 can represent an advanced document model with enhanced user interactions and a modular framework. The intelligent dynamic document 439 can comprise at least a header, body, and a trailer. In some instances, the intelligent dynamic document 439 can have a plurality of data objects.

At block 606, the intelligent document application 446 of the client device 409 can parse the data objects in the intelligent dynamic document 439 that was received. The data objects can represent sets of digital information contained in the intelligent dynamic document 439. In some instances, the data objects can be one or more of code objects 449, image objects 453, video objects 456, text objects 459, annotation objects, or other embedded data. In some instances, the code interpreter 477 can be used to parse the data objects in the intelligent dynamic document 439.

At block 609, the intelligent document application 446 can instantiate the code interpreter 477. The code interpreter 477 can compile code and/or execute code objects 449 in the intelligent dynamic document 439. In some instances, the code interpreter 477 can interact with the large language model 443 based at least in part on the content of the intelligent dynamic document and/or the one or more user inputs. In some examples, the code interpreter 477 can parse commands, translate the one or more commands, and handle errors or exceptions.

At block 613, the intelligent document application 446 of the client device 409 can receive one or more user inputs via the user interface 483. In some instances, the intelligent document application 446 can receive one or more user inputs in the chat interface provided by the chat service 476. The one or more inputs can be commands, queries, annotations, or other similar requests. In some instances, the one or more inputs can be based at least in part on the content of the intelligent dynamic document 439. The one or more user inputs can be entered through a touch screen, keyboard, mouse, voice input, gestures, or other similar input methods.

At block 616, the intelligent document application 446 can process the one or more user inputs. In some instances, processing the one or more user inputs can involve the chat service 476. In other instances, processing the one or more user inputs can involve a code interpreter 477 and/or the large language model 443.

At block 619, the code interpreter 477 of the intelligent document application 446 can execute the large language model 443. Executing the large language model 443 can allow large language model 443 to respond to the one or more user inputs by generating a response. In other examples, activating the large language model 443 to allow the large language model 443 to analyze and process the content of the intelligent dynamic document 439.

At block 623, the code interpreter 477 of the intelligent document application 446 can instruct the large language model 443 to generate a response to the one or more user inputs. In some instances, the generated response or output could be a textual response. In other instances, the generated response or output could be performance of an action.

At block 626, the intelligent document application 446 of the client device 409 can provide one or more outputs based at least in part on the one or more user inputs. In some examples, the outputs can be based at least in part on the parsed content of the intelligent dynamic document 439. In some instances, the outputs can be provided by the large language model 443. In some instances, the outputs can be provided on the chat interface of the chat service 476. In other instances, the output can be the performance of a command, query, annotation, or other similar requests made by the user. In some instances, the response could ask the user for additional information or clarification.

At block 629, the intelligent document application 446 can send one or more notifications 480 based at least in part on an update in the chat service 476. In some instances, the large language model 443 could generate an output or response after a user has minimized the chat interface of the chat service 476. The intelligent document application 446 can notify a user by system alerts, sound alert, pop-up notification, messages, emails, push notifications, or other similar notification styles. The information in the notification 480 can vary based at least in part on the activity causing the notification 480.

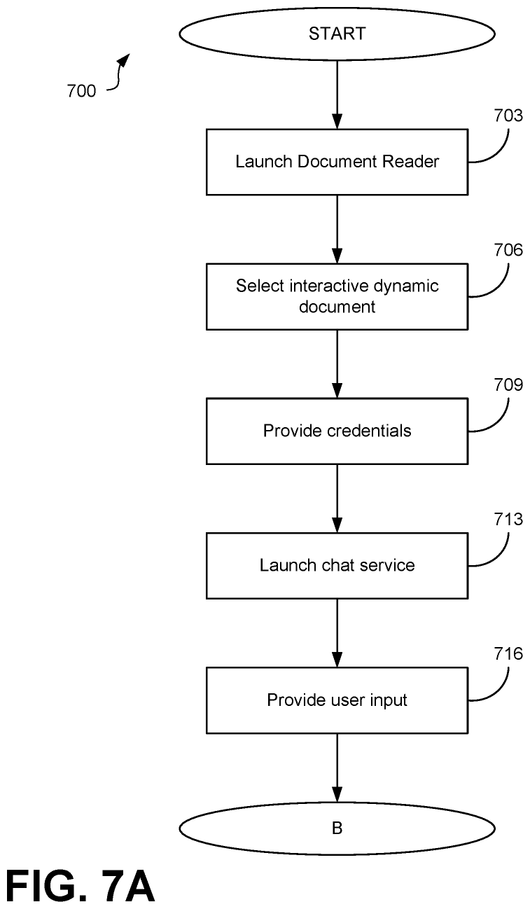

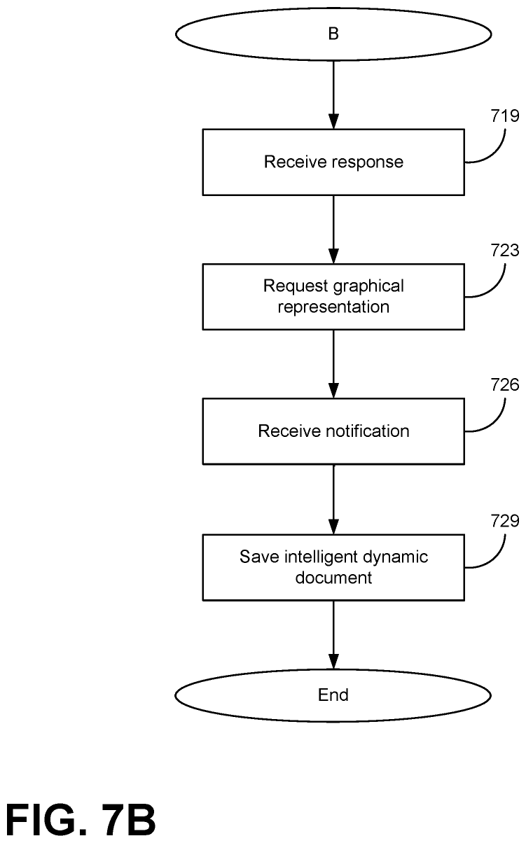

Referring next to FIGS. 7A and 7B, shown is a flowchart that provides one example of the operation of a portion of intelligent document application 446. The flowchart of FIGS. 7A and 7B provides merely an example of the many different types of functional arrangements that can be employed to implement the operation of the depicted portion of the intelligent document application 446. As an alternative, the flowchart of FIGS. 7A and 7B can be viewed as depicting an example of elements of a method implemented within the network environment 400.

Beginning with block 703, the user of the client device 409 can launch the intelligent document application 446. In some instances, launching the intelligent document application 446 can prepare the intelligent document application 446 to receive an intelligent dynamic document 439. In other examples, the user can launch the intelligent document application 446 by navigating to the web address or by launching the mobile or computer application.

At block 706, the intelligent document application 446 of the client device 409 can present the user with one or more options to select an interactive dynamic document 439. The intelligent dynamic document 439 can be loaded from local storage, a cloud-hosted server or repository, or via a link provided by the advanced document system 419.

At block 709, the intelligent document application 446 of the client device 409 can prompt the user of the client device 409 to provide credentials 493 to access the intelligent dynamic document 439. In other examples, the intelligent dynamic document 439 can be decrypted using encryption keys. In some instances, providing the credentials 493 can unlock user roles and permissions for interacting with the intelligent dynamic document 439.

At block 713, the user of the client device 409 can launch the chat service 476 to interact with the intelligent dynamic document 439. In some instances, the chat service 476 can provide the user with a chat interface to interact with the large language model 443 embedded in the intelligent dynamic document 439.

At block 716, the user of the client device 409 can provide, in the chat interface of the chat service 476, one or more user inputs via the user interface 483. The one or more user inputs can be commands, queries, annotations, or other similar requests. In some instances, the one or more user inputs can be based at least in part on the content of the intelligent dynamic document 439.

At block 719, the user of the client device 409 can receive one or more outputs based at least in part on the one or more user inputs. In some examples, the received outputs can be based at least in part on the parsed content of the intelligent dynamic document 439. In some instances, the outputs can be provided by the large language model 443. In some instances, the outputs can be provided on the chat interface of the chat service 476. In other instances, the output can be the performance of a command, query, annotation, or other similar requests made by the user. In some instances, the response could ask the user for additional information or clarification.

At block 723, the user of the client device 409 can request a graphical representation of the parsed content of the intelligent dynamic document 439. In some instances, the graphical representation can be a table, pie graph, flowchart, tree graph, or other similar visual data representation styles.

At block 726, the user of the client device 409 can receive a notification 480 from the intelligent document application 446. In some instances, the large language model 443 could generate an output or response after a user has minimized or closed the chat interface of the chat service 476. The intelligent document application 446 can notify a user by system alerts, sound alert, pop-up notification, messages, emails, push notifications, or other similar notification styles. The information in the notification 480 can vary based at least in part on the activity causing the notification 480.

At block 729, the user of the client device 409 can save the intelligent dynamic document 439. In some instances, the intelligent dynamic document 439 can be saved locally to the client device 409. In other instances, the intelligent dynamic document 439 can be saved to removable media connected to the client device 409. In some examples, the intelligent dynamic document 439 can be saved to the cloud server.

A number of software components previously discussed are stored in the memory of the respective computing devices and are executable by the processor of the respective computing devices. In this respect, the term “executable” means a program file that is in a form that can ultimately be run by the processor. Examples of executable programs can be a compiled program that can be translated into machine code in a format that can be loaded into a random access portion of the memory and run by the processor, source code that can be expressed in proper format such as object code that is capable of being loaded into a random access portion of the memory and executed by the processor, or source code that can be interpreted by another executable program to generate instructions in a random access portion of the memory to be executed by the processor. An executable program can be stored in any portion or component of the memory, including random access memory (RAM), read-only memory (ROM), hard drive, solid-state drive, Universal Serial Bus (USB) flash drive, memory card, optical disc such as compact disc (CD) or digital versatile disc (DVD), floppy disk, magnetic tape, or other memory components.

The memory includes both volatile and nonvolatile memory and data storage components. Volatile components are those that do not retain data values upon loss of power. Nonvolatile components are those that retain data upon a loss of power. Thus, the memory can include random access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, or other memory components, or a combination of any two or more of these memory components. In addition, the RAM can include static random access memory (SRAM), dynamic random access memory (DRAM), or magnetic random access memory (MRAM) and other such devices. The ROM can include a programmable read-only memory (PROM), an erasable programmable read-only memory (EPROM), an electrically erasable programmable read-only memory (EEPROM), or other like memory device.

Although the applications and systems described herein can be embodied in software or code executed by general purpose hardware as discussed above, as an alternative the same can also be embodied in dedicated hardware or a combination of software/general purpose hardware and dedicated hardware. If embodied in dedicated hardware, each can be implemented as a circuit or state machine that employs any one of or a combination of a number of technologies. These technologies can include, but are not limited to, discrete logic circuits having logic gates for implementing various logic functions upon an application of one or more data signals, application specific integrated circuits (ASICs) having appropriate logic gates, field-programmable gate arrays (FPGAs), or other components, etc. Such technologies are generally well known by those skilled in the art and, consequently, are not described in detail herein.

The flowcharts and the sequence diagram show the functionality and operation of an implementation of portions of the various embodiments of the present disclosure. If embodied in software, each block can represent a module, segment, or portion of code that includes program instructions to implement the specified logical function(s). The program instructions can be embodied in the form of source code that includes human-readable statements written in a programming language or machine code that includes numerical instructions recognizable by a suitable execution system such as a processor in a computer system. The machine code can be converted from the source code through various processes. For example, the machine code can be generated from the source code with a compiler prior to execution of the corresponding application. As another example, the machine code can be generated from the source code concurrently with execution with an interpreter. Other approaches can also be used. If embodied in hardware, each block can represent a circuit or a number of interconnected circuits to implement the specified logical function or functions.

Although the flowcharts and the sequence diagram show a specific order of execution, it is understood that the order of execution can differ from that which is depicted. For example, the order of execution of two or more blocks can be scrambled relative to the order shown. Also, two or more blocks shown in succession can be executed concurrently or with partial concurrence. Further, in some embodiments, one or more of the blocks shown in the flowcharts can be skipped or omitted. In addition, any number of counters, state variables, warning semaphores, or messages might be added to the logical flow described herein, for purposes of enhanced utility, accounting, performance measurement, or providing troubleshooting aids, etc. It is understood that all such variations are within the scope of the present disclosure.

Also, any logic or application described herein that includes software or code can be embodied in any non-transitory computer-readable medium for use by or in connection with an instruction execution system such as a processor in a computer system or other system. In this sense, the logic can include statements including instructions and declarations that can be fetched from the computer-readable medium and executed by the instruction execution system. In the context of the present disclosure, a “computer-readable medium” can be any medium that can contain, store, or maintain the logic or application described herein for use by or in connection with the instruction execution system. Moreover, a collection of distributed computer-readable media located across a plurality of computing devices (e.g., storage area networks or distributed or clustered filesystems or databases) may also be collectively considered as a single non-transitory computer-readable medium.

The computer-readable medium can include any one of many physical media such as magnetic, optical, or semiconductor media. More specific examples of a suitable computer-readable medium would include, but are not limited to, magnetic tapes, magnetic floppy diskettes, magnetic hard drives, memory cards, solid-state drives, USB flash drives, or optical discs. Also, the computer-readable medium can be a random access memory (RAM) including static random access memory (SRAM) and dynamic random access memory (DRAM), or magnetic random access memory (MRAM). In addition, the computer-readable medium can be a read-only memory (ROM), a programmable read-only memory (PROM), an erasable programmable read-only memory (EPROM), an electrically erasable programmable read-only memory (EEPROM), or other type of memory device.

Further, any logic or application described herein can be implemented and structured in a variety of ways. For example, one or more applications described can be implemented as modules or components of a single application. Further, one or more applications described herein can be executed in shared or separate computing devices or a combination thereof. For example, a plurality of the applications described herein can execute in the same computing device, or in multiple computing devices in the same computing environment 403.

Disjunctive language such as the phrase “at least one of X, Y, or Z,” unless specifically stated otherwise, is otherwise understood with the context as used in general to present that an item, term, etc., can be either X, Y, or Z, or any combination thereof (e.g., X; Y; Z; X or Y; X or Z; Y or Z; X, Y, or Z; etc.). Thus, such disjunctive language is not generally intended to, and should not, imply that certain embodiments require at least one of X, at least one of Y, or at least one of Z to each be present.

It should be emphasized that the above-described embodiments of the present disclosure are merely possible examples of implementations set forth for a clear understanding of the principles of the disclosure. Many variations and modifications can be made to the above-described embodiments without departing substantially from the spirit and principles of the disclosure. All such modifications and variations are intended to be included herein within the scope of this disclosure and protected by the following claims.

1. A system, comprising:
a computing device comprising a processor, a memory, and a display; and
an intelligent document application comprising machine-readable instructions stored in the memory that, when executed by the processor, cause the computing device to at least:
display a user interface on the display of the computing device, wherein at least a portion of an intelligent dynamic document is presented within the user interface;
receive a prompt via the user interface;
execute a large language model (LLM) to generate a response to the prompt, wherein the LLM is embedded within the intelligent dynamic document and the response is based at least in part on the content of the intelligent dynamic document; and
present the response within the user interface.

2. The system of claim 1, wherein the LLM is compressed and the machine-readable instructions, when executed by the processor, further cause the computing device to at least decompress the LLM prior to execution.

3. The system of claim 1, wherein the machine-readable instructions that cause the computing device to execute the LLM embedded within the intelligent dynamic document further cause the computing device to at least load the LLM into a code interpreter, wherein the code interpreter is a component of the intelligent document application.

4. The system of claim 1, wherein the machine-readable instructions of the intelligent document application, when executed by the processor, further cause the computing device to at least:
execute the LLM to offer a suggested annotation for the intelligent dynamic document; and
present the suggested annotation within the user interface.

5. The system of claim 1, wherein the intelligent dynamic document comprises at least one of a code object, an image object, a video object, a text object, or an annotation object.

6. The system of claim 1, wherein the response is a graphical representation of data within the intelligent dynamic document.

7. The system of claim 1, wherein the LLM is trained on the contents of the intelligent dynamic document.

8. A method, comprising:
showing a user interface on a display of a computing device, wherein at least a portion of an intelligent dynamic document is presented within the user interface;
receiving a prompt via the user interface;
executing a large language model (LLM) to generate a response to the prompt, wherein the LLM is embedded within the intelligent dynamic document and the response is based at least in part on the content of the intelligent dynamic document; and
presenting the response within the user interface.

9. The method of claim 8, wherein the LLM is compressed and the method further comprises decompressing the LLM prior to executing the LLM.

10. The method of claim 8, wherein executing the LLM embedded within the intelligent dynamic document further comprises loading the LLM into a code interpreter.

11. The method of claim 8, further comprising:
executing the LLM to offer a suggested annotation for the intelligent dynamic document; and
presenting the suggested annotation within the user interface.

12. The method of claim 8, wherein the intelligent dynamic document comprises at least one of a code object, an image object, a video object, a text object, or an annotation object.

13. The method of claim 8, wherein the response is a graphical representation of data within the intelligent dynamic document.

14. The method of claim 8, wherein the LLM is trained on the contents of the intelligent dynamic document.

15. A non-transitory, computer-readable medium comprising machine-readable instructions that represent an intelligent document application, when executed by a processor of a computing device, cause the computing device to at least:
show a user interface on a display of the computing device, wherein at least a portion of an intelligent dynamic document is presented within the user interface;
receive a prompt via the user interface;
execute a large language model (LLM) to generate a response to the prompt, wherein the LLM is embedded within the intelligent dynamic document and the response is based at least in part on the content of the intelligent dynamic document; and
present the response within the user interface.

16. The non-transitory, computer-readable medium of claim 15, wherein the LLM is compressed and the machine-readable instructions, when executed by the processor, further cause the computing device to at least decompress the LLM prior to execution.

17. The non-transitory, computer-readable medium of claim 15, wherein the machine-readable instructions that cause the computing device to execute the LLM embedded within the intelligent dynamic document further cause the computing device to at least load the LLM into a code interpreter, wherein the code interpreter is a component of the intelligent document application.

18. The non-transitory, computer-readable medium of claim 15, wherein the machine-readable instructions of the intelligent document application, when executed by the processor, further cause the computing device to at least:
execute the LLM to offer a suggested annotation for the intelligent dynamic document; and
present the suggested annotation within the user interface.

19. The non-transitory, computer-readable medium of claim 15, wherein the response is a graphical representation of data within the intelligent dynamic document.

20. The non-transitory, computer-readable medium of claim 15, wherein the LLM is trained on the contents of the intelligent dynamic document.
